(19) United States
(12) Patent Application Publication
(10) Pub. No.: US 2025/0203329 A1
(43) Pub. Date: Jun. 19, 2025

(54) USER EQUIPMENT AND ROADSIDE UNIT BASED VIRTUAL CELL FOR VEHICLE-TO-INFRASTRUCTURE COMMUNICATION

(71) Applicant: Continental Automotive Technologies GmbH, Hannover (DE)

(72) Inventors: David Gonzalez Gonzalez, Egelsbach (DE); Abdelkarim Belhoula, Asslar (DE); Claus Chrometz, Butzbach (DE); Andreas Andrae, Frankfurt am Main (DE); Osvaldo Gonsa, Frankfurt (DE); Rikin Shah, Langen (DE)

(73) Assignee: Continental Automotive Technologies GmbH, Hannover (DE)

(21) Appl. No.: 18/843,433

(22) PCT Filed: Mar. 2, 2023
(86) PCT No.: PCT/EP2023/055262

§ 371 Date: Sep. 3, 2024

(30) Foreign Application Priority Data
Mar. 2, 2022 (DE) 10 2022 202 127.4

(51) Int. Cl. H04W 4/40; H04W 36/32; H04W 76/15; H04W 88/04; H04W 92/18

(52) U.S. Cl. CPC H04W 4/40; H04W 36/32; H04W 76/15; H04W 88/04; H04W 92/18

(57) ABSTRACT

A user equipment centric cell including a user equipment (UE) that employs standardized vehicle-to-everything (V2X) messages and that includes at least a roadside unit (RSU) having sidelink (SL) groupcast capability.

### CROSS-REFERENCE TO RELATED APPLICATIONS

The present application is a National Stage Application under 35 U.S.C. § 371 of International Patent Application No. PCT/EP2023/055262 filed on Mar. 2, 2023, and claims priority from German Patent Application No. 10 2022 202 127.4 filed on Mar. 2, 2022, in the German Patent and Trademark Office, the disclosures of which are herein incorporated by reference in their entireties.

### TECHNICAL FIELD

The present application relates to virtual user equipment (UE) centric cells and millimeter wave connectivity, and more particularly to a UE-centric cell that employs standardized vehicle-to-everything (V2X) messages and sidelink-based groupcast type of communication between the mobile UE and roadside unit(s) (RSU).

### BACKGROUND

Millimeter wave (mmW) based communication is key to supporting very high data rates, such as sharing massive, high-resolution sensing data, and high-capacity links in vehicle-to-vehicle (V2V) and vehicle-to-infrastructure (V2I) scenarios.

Ultra-Dense Networks (UDNs) are expected to be key to supporting millimeter wave communications and automotive or vehicular use cases. In one example of applying UDN with respect to automotive or vehicular use cases, perception of vehicle surroundings is important for advanced driver assistance systems (ADAS), automated driving, and other vehicular applications, and in particular, autonomous vehicular applications. Some vehicular systems include radar, lidar, vision, and ultrasound for sensing vehicle surroundings and controlling operation of the vehicle based on the vehicle surroundings. Accordingly, V2X can enable ego-perception of surroundings into cooperative perception.

Standardized V2X messaging includes basic awareness messaging, for example Cooperative Awareness Messages (CAMs), Cooperative Perception Messages (CPMs), Maneuver Coordination Messages (MCMs), Basic Safety Messages (BSMs). Such V2X messaging enables a vehicle to share sensor information from on-board sensors, such as radar, lidar, vision, and ultrasound, as well as other information including position, speed, status, trajectory, etc. This information can be exchanged both among vehicles in V2V communication, between vehicles and infrastructure in V21 communication, and other entities in V2X communication. Given the potentially high number of vehicle sensing systems, the need for frequent communication, and other factors, the amount of data to be transmitted can be large. Consequently, mmW communication and UDNs are expected to play a crucial role in achieving the connectivity requirements in many advanced automotive use cases.

FIG. 1 illustrates user equipment (UE) centric virtual/mobile cells and a UDN.

As illustrated in FIG. 1, a UDN 100 includes a base station, such as an eNodeB (eNB) 110, a gNodeB (gNB), etc., mobile edge computing (MEC) services 120, and a roadside unit (RSU) 130, which may be sidelink capable. Vehicle-mounted user equipment (UE) 140, which may also be sidelink capable, may connect to the UDN for forming UE-centric virtual/mobile cells.

### BRIEF SUMMARY

Aspects of embodiments of the present application relate to a UE-centric cell that employs standardized vehicle-to-everything (V2X) messages and that includes a roadside unit (RSU) having sidelink (SL) groupcast capability.

Aspects of embodiments of the present application relate to creating and maintaining sidelink-groupcast-based virtual (UE-centric) cells using standardized V2X messages and Multi-access Edge Computing (MEC), also referred to as Mobile Edge Computing.

Aspects of embodiments of the present application relate to a logical (virtual) moving cell, where information exchange is facilitated via sidelink groupcast, including at least one permanent mobile member. In the example of vehicle platooning, more than one vehicle-mounted UE may be a permanent member of the moving cell.

Aspects of embodiments of the present application relate to a logical (virtual) moving cell created according to a sidelink groupcast configuration and maintained based on, at least, standardized ITS messages, for example based on proximity, and additional information may be leveraged, such as planned trajectory, speed, thus updating the UE-centric group in a timely manner.

Aspects of embodiments of the present application relate to creating the moving cells and maintaining the moving cells using the ITS service (e.g., hosted in a MEC entity) and standardized V2X messaging.

### Technical Problem

Using a gNB-based UDN, mobility management may be problematic because cells are very small, the level of mobility is high, and hence, mobility is inherently problematic from the conventional handover perspective, i.e., many cell-transfers are needed in short periods of time.

Accordingly, an advantage of a UE-centric cell is that the mobile UE does not need to track the network, as conventionally done in cellular networks using handover. Rather, it is the network that tracks the UE and defines the cell around the UE. However, cell management in UE-centric cells does not account for or leverage useful application data such as positioning, speed, or direction of movement, which undesirably limits mobility management.

### Solution to Problem

In view of the above, aspects of embodiments of the present application relate to further enhancing UE-centric cells for V2X. In particular, virtual moving cells, or simply UE-centric cells provide an enhanced strategy to support and cope with UE mobility. Consequently, aspects of embodiments of the present application relate to a user-centric cell that combines the principles of sidelink groupcast and V2X.

### Advantageous Effects

Aspects of embodiments of the present application provide a proposed scheme, based on UE-centric cells, that eliminates the need for frequent Uu-based (inter-cells) handovers, which make the mobility management difficult and result in high signaling overhead.

Aspects of embodiments of the present application provide moving UE-centric cells, which may rely on faster and more agile beam-tracking procedures, instead of handovers to address inherent mobility of the vehicle-based UE.

Aspects of embodiments of the present application relate to the use of information contained in standardized V2X messages, which would create opportunities for creation and management of more intelligent and proactive UE-centric cells.

Aspects of embodiments of the present application, being based on groupcast, create natural diversity for additional communication reliability of UE-centric cells.

### BRIEF DESCRIPTION OF THE DRAWINGS

The above and other aspects will be more clearly understood from the following brief description taken in conjunction with the accompanying drawings, in which:

FIG. 1 illustrates user equipment (UE) centric virtual/mobile cells and a UDN;

FIGS. 2, 3, 4, and 5 illustrate user equipment (UE) centric virtual/mobile cells and a UDN, according to an embodiment; and

FIG. 6 illustrates resource allocation and gNB assistance for user equipment (UE) centric virtual/mobile cells and a UDN, according to an embodiment.

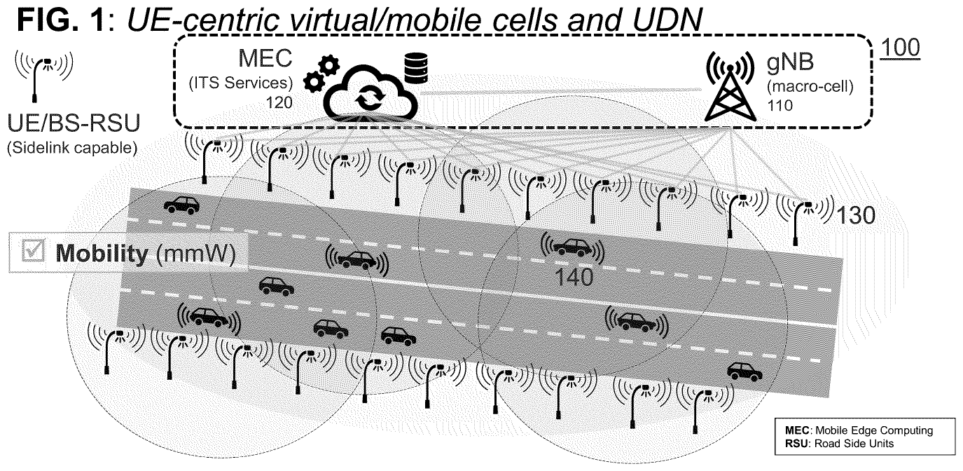

### DETAILED DESCRIPTION

In many contemporary wireless systems, such as 4G and 5G, direct communication between a UE may be provided with or without network coverage. Other non-cellular systems such as WiFi also provide such functionality, such as infrastructure-less WiFi. In 4G and 5G, direct communication (e.g., between UE or vehicles) is realized by means of the PC5 interface, commonly known as sidelink. Sidelink is also the interface used in 5G to enable V2X communications, particularly V2V, V2P, V21. In 4G (LTE) only one communication mode is possible using sidelink: broadcast. However, in 5G, sidelink allows broadcast, unicast, and groupcast. Groupcast implies that one UE transmits a message intended for a specific group of recipients or UEs over the PC5 interface.

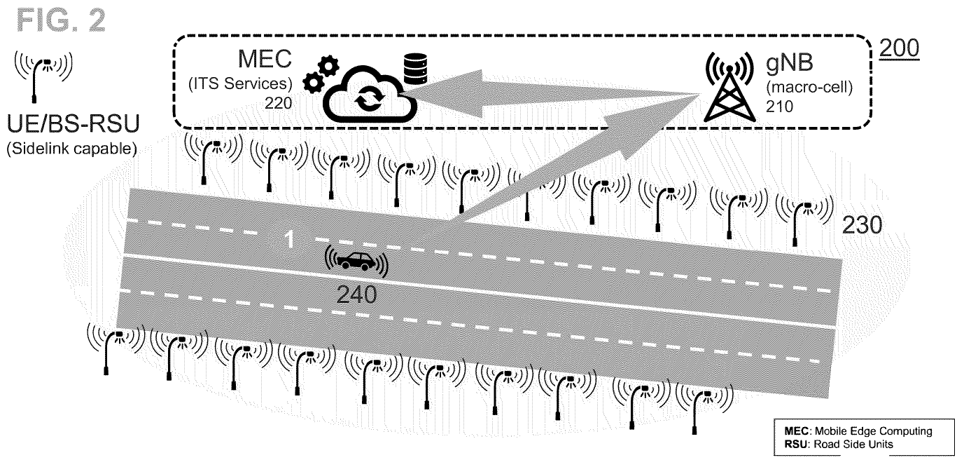

FIGS. 2, 3, 4, and 5 illustrate user equipment (UE) centric virtual/mobile cells and a UDN, according to an embodiment.

As illustrated in FIGS. 2, 3, 4, and 5, a UDN 200 includes a base station 210, such as an eNodeB (eNB), a gNodeB (gNB), etc., mobile edge computing (MEC) services 220, and a roadside unit (RSU) 230, which may be sidelink capable.

The vehicle-mounted mounted user equipment (UE) 240, which may also be sidelink capable, may connect to the UDN for forming UE-centric virtual/mobile cells. Examples of the vehicle-mounted UE 240 include any type of mobile user equipment configured to communicate according to one or more high speed communications standards including mmW, 5G, 6G, etc., and may be integrated in any type of automated vehicle or robot, such as delivery robots, automated shuttles, or trains for people and goods (logistics).

Initially, as illustrated in FIG. 2, a vehicle-mounted UE 240 can connect to a base station 210 in the UDN 200. The vehicle-mounted UE 240 may report its metadata, such as positioning, identifier (ID), V2X services, etc., via the macrocell 210 to the corresponding ITS service in the MEC node 220.

Communication with the macrocell may be only necessary at an initialization between the vehicle-mounted UE 240 and the UDN 200 to obtain the communication parameters to be utilized with sidelink communication. However, as illustrated in FIG. 2, the RSU may be connected directly to both the macrocell 210 and MEC 220. Accordingly, from a V2X communication perspective, all the uplink and downlink traffic could flow through the UE-centric cell.

In an alternative embodiment, the base station 210 may serve as a relay, as V2X messages are typically received by an V2X application server on an infrastructure interface. Such V2X application server functionality may be hosted in the MEC platform 220, which provides additional intelligence and capabilities to the system.

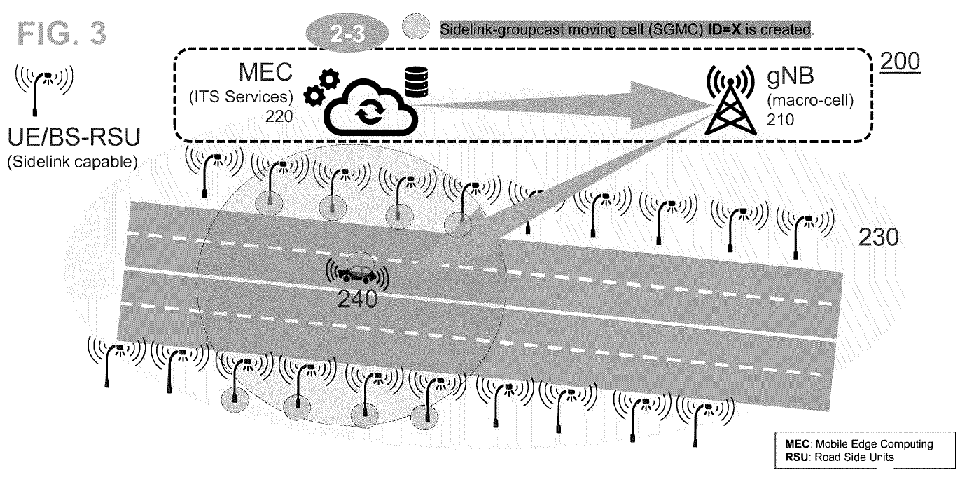

As illustrated in FIG. 3, the macrocell 210 may relay data traffic to the MEC node 220, which incorporates a dedicated ITS service that, based on the received, UE-specific V2X messages, determines and configures a sidelink-groupcast moving cell (SGMC) for the corresponding UE 240 (ID=X). Further selection criteria may be, for example, UE speed, driving direction, or vehicle-mounted antenna configuration. As an example of applying the selection criteria, if the UE antennas are only capable of communication towards certain directions, RSUs in non-covered directions may be excluded for consideration of group creation.

In an alternative embodiment, data from the vehicle and/or vehicle-mounted UE 240, such as in the form of standardized V2X messages, can also be forwarded from RSU 230 to MEC 220. Accordingly, the provision of V2X information may be alternatively provided from the vehicle-mounted UE 240 to the various components of the UDN 200.

The SGMC configuration (as determined by the MEC node 220) is provided (via downlink signaling of the attached gNB) to the corresponding UE as well as the (locally) relevant UE-RSUs.

Maintenance of the UE-centric virtual moving cell may be performed according to application messages, such as standardized V2X messages, and providing the connectivity to the moving UE via the UE-centric virtual moving cell using a direct group-type of communication (e.g., 5G sidelink groupcast). The UE-centric moving cell may be dynamically recalculated, for example including the members of the group: the fixed UE member and the dynamically determined subset of the RSUs 230, based on the mobility of the UE 240 by a centralized entity, such as the MEC 220.

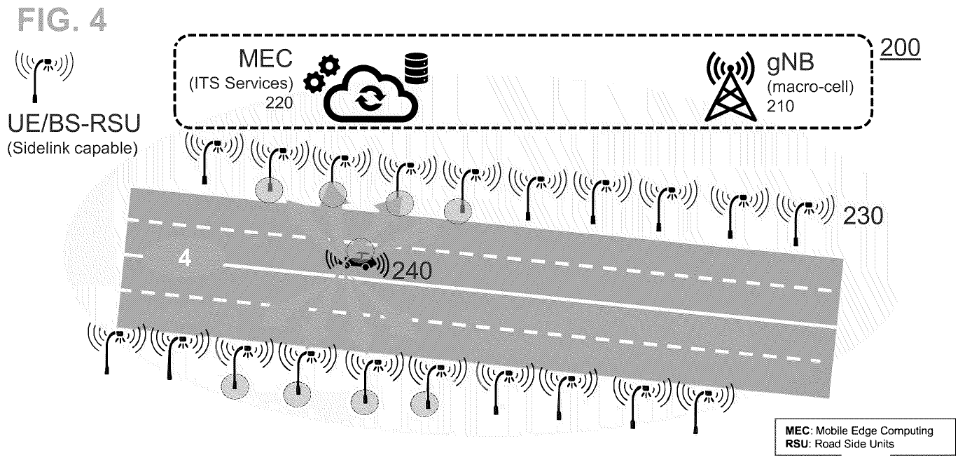

As illustrated in FIG. 4, subsequently initiated data traffic from the UE 240 to the infrastructure or network (logical uplink) is sent as groupcast communication and according to the provided SGMC configuration, which will be received by the UE-RSUs in the group with ID=X via the respective sidelink channel.

Part of this data traffic could be other user payload, such as data of other applications. Alternatively or additionally, part of this data traffic may be standardized V2X messages, which may be used by the MEC-hosted ITS service, for example, to update the group according to this information, including for example location, direction, and speed. As a result, if so, the relevant UE-RSU set may be updated.

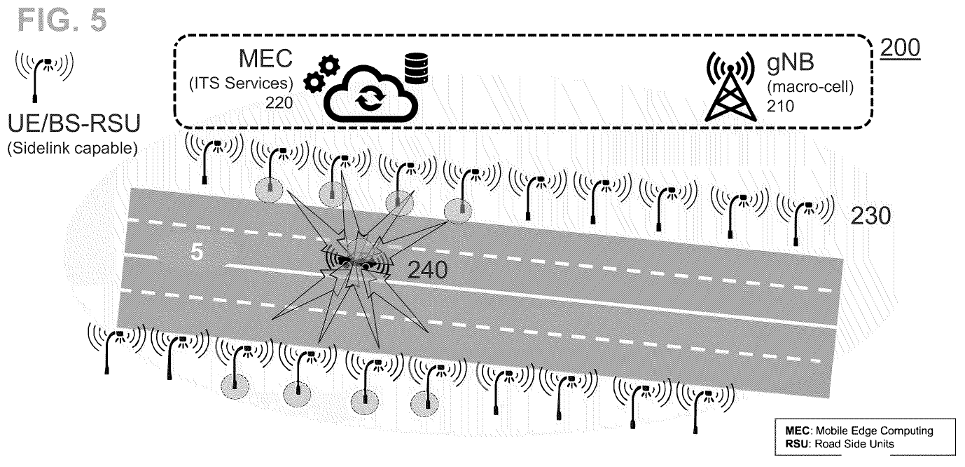

As illustrated in FIG. 5, downlink data traffic may follow similar operation, where the mobile UE benefits from the diversity of the different UE-RSUs. Accordingly, the group or cell is updated according to standardized messages for enhanced communication reliability.

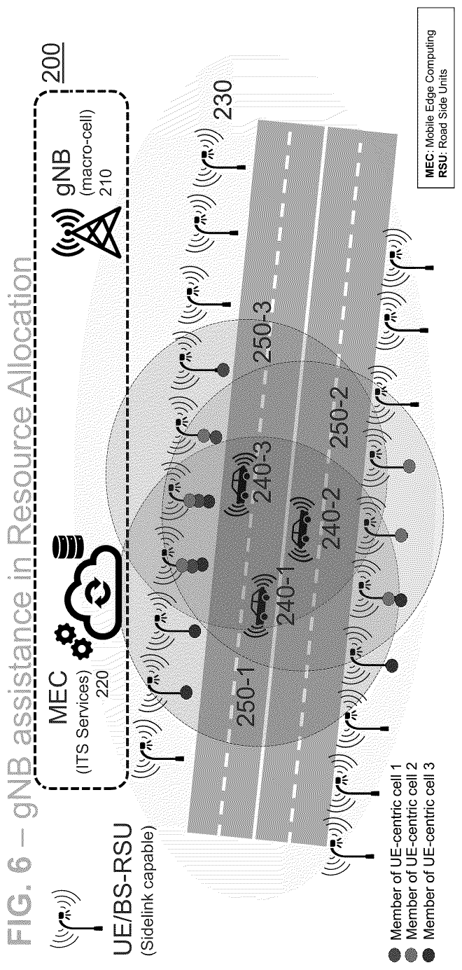

FIG. 6 illustrates resource allocation and gNB assistance for user equipment (UE) centric virtual/mobile cells and a UDN, according to an embodiment.

As illustrated in FIG. 6, a plurality of UE-centric cells 250-1, 250-2, 250-3 may be present. A first UE-centric cell 250-1 includes a first vehicle-based UE 240-1 and a first plurality of RSUs, a second UE-centric cell 250-2 includes a second vehicle-based UE 240-2 and a second plurality of RSUs, and a third UE-centric cell 250-3 includes a third vehicle-based UE 240-3 and a third plurality of RSUs.

In the case of a dedicated/common resource pool for the moving cells, which can also be allocated per geographical zone or region, a gNB can coordinate (using currently specified features) the resource allocation in a Mode-1 fashion or using Semi-Persistent Scheduling (SPS).

For a Mode-2 type of operation, the autonomous selection should be made by the UE, which use pre-configured radio resources for initiating sidelink groupcast and creation of the UE-centric cell including a group of RSUs within communication range. Again, the ITS service is hosted by a MEC node, which is integrated in or connected to at least one of the RSUs.

### INDUSTRIAL APPLICABILITY

Embodiments of the present application are relevant for many scenarios in which vehicular communications are needed, such as road segments and smart cities where UE-RSU and MEC nodes are available. In particular, the present application provides a flexible and reliable way to support sensor data sharing and cooperative perception, which is important for enhancing road safety and automated driving.

Accordingly, instances relevant to the present application include scenarios, such as road segments and intersections, in which ultra-dense UE-RSU are deployed, for supporting vehicular applications including local dynamic maps, cooperative perception, etc.

Embodiments of the present application including the moving sidelink/groupcast-based cell can be easily handled using in-core-network tables (mapping each vehicle mounted UE onto UE-RSUs).

Embodiments of the present application may be transparent to vehicle mounted UE and are aggregable.

Embodiments of the present application may be compatible with many combinations of frequency bands, such as FR1 and/or FR2, and/or licensed/unlicensed frequency bands for both indirect (e.g., via Uu) and direct device-to-device (D2D) communications, e.g., via PC5.

Embodiments of the present application provide diversity in transmission (TX) and reception (RX), and resource allocation flexibility, as both uplink and downlink procedures can be complemented opportunistically using the sidelink resources. Consequently, quite asymmetric configurations can be adapted to application data traffic demands.

### REFERENCE SIGNS LIST

100 Ultra Dense Network
110 Base Station
120 Mobile Edge Computing
130 Roadside Unit
140 Vehicle-Mounted User Equipment
200 Ultra Dense Network
210 Base Station
220 Mobile Edge Computing
230 Roadside Unit
240 Vehicle-Mounted User Equipment
240-1 Vehicle-Mounted User Equipment
240-2 Vehicle-Mounted User Equipment
240-3 Vehicle-Mounted User Equipment
250-1 User Equipment Centric Cell
250-2 User Equipment Centric Cell
250-3 User Equipment Centric Cell

1. A system comprising:
a plurality of roadside units configured to communicate via sidelink;
a user equipment; and
a mobile edge computing ITS service configured to determine a configuration of a sidelink groupcast moving cell comprising the user equipment and the plurality of roadside units, wherein the user equipment is configured to communicate with the plurality of roadside units via sidelink groupcast based on the configuration of the sidelink groupcast moving cell.

2. The system of claim 1, wherein the user equipment is configured to operate as a transceiver, in combinations of frequency bands and/or licensed/unlicensed frequency bands for both indirect communications and direct device-to-device (D2D) communications.

3. The system of claim 2, wherein the frequency bands comprise FR1 and/or FR2.

4. The system of claim 3, wherein the indirect communications comprise Uu communications and the D2D communications comprise PC5.

5. The system of claim 4, further comprising a base station configured to relay metadata from the user equipment to the mobile edge computing ITS service to generate the sidelink groupcast moving cell.

6. The system of claim 4, wherein the mobile edge computing ITS service comprises a mobile edge computing platform included in at least one roadside unit among the plurality of roadside units, the mobile edge computing platform of the at least one roadside unit configured to relay metadata from the user equipment to the mobile edge computing ITS service, and
wherein the mobile edge computing ITS service generates the sidelink groupcast moving cell based on the metadata.

7. A method of multi-access edge-computing (MEC) service providing virtual user equipment (UE)-centric cells as a service in a wireless communication environment, the method comprising:
receiving, by at least one MEC device, vehicle-to-everything (V2X) messages comprising at least one of geographical reference information, an identifier of a UE transmitting entity, and additional entity-specific or situation-specific metadata;
computing, based on the V2X messages and a database of geographical reference information of roadside units (RSUs), a UE-specific set of relevant RSUs;
determining, for each UE-specific set of RSUs, a unique identifier and group reference maintained by the MEC service; and
providing the unique identifier and the group reference to the UE subscribed to a UE-centric cell creation service (UCCS).

8. The method of claim 7, wherein receiving the V2X messages comprises communicatively interfacing with a V2X server instance that decodes and provides received data to the UCCS.

9. The method of claim 7, wherein the computing comprises:
creating a data structure using a database of geographical reference information of RSUs; and
applying a group formation algorithm that processes the georeferenced information, calculates UE-specific groups, and accounts for further selection criteria.

10. The method of claim 7, wherein the determining comprises creating and maintaining a registry of service subscribers as well as a database of determined, UE-specific set of relevant RSUs.

11. The method of claim 7, wherein the providing comprises addressing and transmitting the determined result of the UCCS to the corresponding UE.

12. The method of claim 7, wherein the database of UE-specific set of relevant RSUs is MEC hosted and continuously updated based on UE-specific V2X messages received within a service domain of the at least one MEC device.

13. A multi-access edge-computing (MEC) device associated with a plurality of ITS services, the mobile edge computing device comprising at least one communication interface, a memory, and one or more processors communicatively coupled with the communication interface and memory and configured with processor-executable instructions to perform operations of a multi-access edge-computing (MEC) service providing virtual user equipment (UE)-centric cells as a service in a wireless communication environment the operations comprising:
receiving by at least one MEC device, vehicle-to-everything (V2X) messages comprising at least one of geographical reference information, an identifier of a UE transmitting entity, and additional entity-specific or situation-specific metadata;
computing based on the V2X messages and a database of geographical reference information of roadside units (RSUs), a UE-specific set of relevant RSUs;
determining for each UE-specific set of RSUs, a unique identifier and group reference maintained by the MEC service; and
providing the unique identifier and the group reference to the UE subscribed to a UE-centric cell creation service (UCCS).

14. The MEC device according to claim 13, wherein the MEC is a base station, mobile network node, roadside unit (RSU), roadside access point (RAP), node or server with edge computing functions, situated in proximity to a respective service domain comprising at least one of a highway or road, a city, a metropolitan area, a manufacturing site, an industrial facility, a port, a freight depot and a logistics hub.
